(19) United States
(12) Patent Application Publication
(10) Pub. No.: US 2008/0024388 A1
(43) Pub. Date: Jan. 31, 2008

(54) Two-sided display monitor apparatus

(76) Inventor: Oscar Bruce, Freeport, NY (US)

Correspondence Address: Mark Sgantzos;THE MARTINEZ GROUP PLLC, Suite 323, 55 Washington Street (Dumbo), Brooklyn, NY, 11201-1070, US

(21) Appl. No.: 11/495,937

(22) Filed: Jul. 29, 2006

(51) Int. Cl. G09G 5/00

(52) U.S. Cl. 345/1.1

(57) ABSTRACT

A display apparatus such as liquid crystal displays (LCD) or plasma displays or any other type of thin or flat display monitor apparatus having multiple display screens. The multiple display screens either consisting of double sided display screens, being slidingly engaged in a monitor housing having rails or being attached by a multiple axis pivot structure. The screens can be either controlled by a single control structure or can be independently controlled by multiple control structure where multiple users can work on each respective screen independently from one another.

### FIELD OF INVENTION

The present invention relates generally to electronic display apparatus such as liquid crystal displays (LCD) or plasma displays or any other type of thin or flat display monitor apparatus incorporating multiple display screens.

### BACKGROUND OF THE INVENTION

Many users of information and entertainment providing apparatus, such as computers, televisions, gaming and game-playing devices utilize multiple monitors to better view, compare and display the information, games or entertainment being displayed. The falling price of LCD and plasma-type displays has resulted in many users of such devices seeking to acquire and use multiple monitors.

The use of multiple monitors for a single user is well known and many instances of prior-art exist wherein a multiplicity of display monitors in varying configurations have been disclosed. However, there are no suitable solutions for displaying information to multiple viewers when those viewing the information are sitting in a face-to-face orientation. At the present time, professionals sitting at a desk wishing to show information on a computer monitor must either re-orient the seating arrangement of the offices or physically turn their monitor screen so as to permit the viewing of the displayed information to the second viewer.

Moreover, in games of chance and entertainment-type game-playing activities, the ability to display information to others who are facing the player/user, either as a viewer or as an opponent to the player/user, would be very advantageous. By way of example, not limitation, in certain types of computer-based card games of chance activities, the ability to display the face-up playing cards on a monitor visible to an opponent would facilitate multiple player computerized games of chance activities in both private, or live casino play or virtual game playing environments. By way of further example, not limitation, two or more players in a computer based entertainment game would be able to compete in a face-to-face orientation, thereby enhancing the game playing experience.

However, there may be occasions when it is not desirable to use the second monitor apparatus, such as when privacy is required or when the safety of outward facing monitor apparatus is associated with a portable lap-top or note-book type of mobile computer may be a concern. It is further noted that there may occasions when it may be desired to use the second monitor of the present invention in such a manner as to present both monitors to the user or, when folded, as is disclosed in the present application, in such a manner as to provide for a tablet-type portable computer.

Thus, there currently exists a need to provide two-sided monitor display apparatus which is both convenient to use and is easily deployed while providing the option of either storing or protecting the outside facing monitor according to the needs or desires of the user.

### SUMMARY OF THE INVENTION

A two-sided display monitor apparatus is disclosed herein. One aspect of the present invention according to a first preferred embodiment is a two-sided display monitor apparatus wherein the two display screens are fixed in a back-to-back position within a single frame or bezel, permitting viewing of the display screen monitors from opposing vantages, the second display screen monitor being protected when not in use by the use of a detachable cover.

One aspect of the present invention according to a second preferred embodiment is a two-sided display screen monitor apparatus wherein the second display screen monitor is attached by a double pivot hinge so as to permit the second screen to be folded in for storage and safe keeping and folded out for use, wherein the second display screen is attached to the double pivot hinge, by means of a rotating hinge portion so as to permit the rotation of the second display screen so that it may be viewed from either side, as may be desired by the user or in that it can be folded closed with respect to the first screen so that the screen is not subject to damage.

A further aspect of the present invention according to the second preferred embodiment is to attach the second display screen monitor to the double pivot hinge, a portion of double pivot hinge being attached to the second display screen monitor with a rotating portion so as to permit the rotation and folding of the second display screen monitor into a closed position permitting the use of the second display screen monitor as a touch screen-type display monitor for use in a tablet-type personal computer.

One aspect of the present invention according to a third preferred embodiment is a two-sided display screen monitor apparatus wherein the second display screen can be deployed by means of sliding the entire screen out from a screen frame or bezel, by means of a set of rails on the frame or bezel, manually rotating the second monitor so as to face opposite the primary screen display monitor, and returning the second monitor by sliding the second screen monitor back into the screen frame or bezel for use as the opposed, second, display screen monitor.

A further aspect of the present invention is that in all the above three embodiments, both screens can be either controlled by a single controller, either by means of a keyboard and mouse or other conventional control apparatus, or by multiple control apparatus whereby the screens function independently of each other in order to permit multiple users on a single entertainment apparatus as defined above. The entertainment apparatus being provided by well-known means as to connect multiple control apparatus.

### BRIEF DESCRIPTION OF THE DRAWINGS

The two-sided display monitor apparatus of the present invention being described herein is described as follows, reference being made to the drawings wherein:

FIG. 1 is front isometric view of an embodiment of the present invention showing, among other features, the primary display monitor of two-sided display monitor apparatus wherein the two display monitors are opposedly housed in a single display case.

FIG. 1a is a rear isometric view of an embodiment of the present invention showing, among other features, the secondary display monitor of two-sided display monitor apparatus wherein the two display monitors are opposedly housed in a single display case.

FIG. 1b is a rear isometric view of an embodiment of the present invention showing, among other features, the secondary display monitor of two-sided display monitor apparatus further showing a removable protective cover fitting over the secondary display monitor.

FIG. 1c is a rear isometric view of an embodiment of the present invention showing, among other features, the secondary display monitor of two-sided display monitor apparatus further showing protective cover hingedly attached so as to cover the secondary display monitor.

FIG. 2 is a front isometric view of the second preferred embodiment of the present invention showing, among other features, two independently housed display monitors attached by a double pivot-type hinge whereby the hinge can be rotated.

FIG. 2a is a front isometric view of the second embodiment of the present invention showing, among other features, two independently housed display monitors attached by a double pivot-type hinge, both displays being oriented in an upright vertical arrangement such that the primary user can view both display monitors.

FIG. 2b is a side elevation view of the second embodiment of the present invention showing, among other features, two independently housed display monitors attached by the double pivot-type hinge, both displays being oriented in an upright vertical arrangement. The upper display monitor being rotated slightly along a center vertical axis showing a protective cover which is disposed on the back of the upper display monitor.

FIG. 2c is a side elevation view of the second embodiment of the present invention showing, among other features, two independently housed display monitors attached by a double pivot-type hinge, both displays being oriented in an upright vertical arrangement, the upper display monitor being rotated slightly along a center vertical axis showing the display surface of the upper display monitor.

FIG. 2d is a side elevation view of an embodiment of the present invention showing, among other features, two independently housed display monitors attached by the double pivot-type hinge, said displays being oriented in an opposing manner such that the secondary display monitor is viewed from the side opposing the primary display monitor.

FIG. 2e is a side elevation view of the second embodiment of the present invention showing, said displays being oriented such that the secondary display is oriented in the same manner as the primary display monitor resulting in the protective cover of the secondary display monitor being disposed towards the outside of the surface so as to protect the display monitors of the present invention.

FIG. 2f is an isometric view of an embodiment of the present invention showing, among other features, the secondary display monitor folded onto the primary display monitor, said monitors being substantially in the closed position over a dual display apparatus, the secondary display being outwardly disposed such that the surface of the secondary display monitor can be used as a touch sensitive-type display for the reading and input of information by the user, as in a tablet type monitor.

FIG. 3 is an isometric view of the third embodiment of the present invention showing, among other features, a single display monitor case sufficiently large enough to contain two separate oppositely facing display monitors.

FIG. 3a is an elevation view of the third embodiment showing, a single display monitor case sufficient to contain two opposedly displayed display monitors of the present invention, the secondary display monitor being shown slidingly removed in a vertical manner from the single monitor case housing the display monitors, the secondary display monitor being. capable of being manually removed and rotated so as to dispose the viewing surface of said display either towards or away from the primary user.

FIG. 3b is an isometric view of the third embodiment of the present invention showing a single display monitor case sufficient to contain two opposedly displayed display monitors of the present invention, the secondary display monitor being shown slidingly removed in a vertical manner from the single monitor case housing the display monitors, the removed secondary display monitor shown rotated on its vertical axis so as to dispose the viewing surface of said display towards the secondary user of the present invention.

FIG. 3c is an isometric view of the third embodiment of the present invention showing a single display monitor case sufficient to contain two opposedly displayed display monitors of the present invention, the secondary display monitor being shown slidingly removed in a vertical manner from the single monitor case housing the display monitors, the removed secondary display monitor shown rotated on its vertical axis showing a protective cover which is disposed on the back of the removed secondary display monitor.

### DETAILED DESCRIPTION OF THE INVENTION

The two-sided display monitor apparatus, typically in the form of a two sided dual display apparatus is disclosed together with numerous variations each within the scope of the invention. Such an apparatus is suited for applications where dual display screens or opposedly displayed display screens or collapsed display screens are preferred or occasionally required either in a stand alone or attached to a lap-top or portable computer may be easily accessed, operated and then stored in a quick and efficient manner. Access implies opening, folding, rotating or extending the associated display monitors; storing implies folding, closing or retracting the associated display monitors.

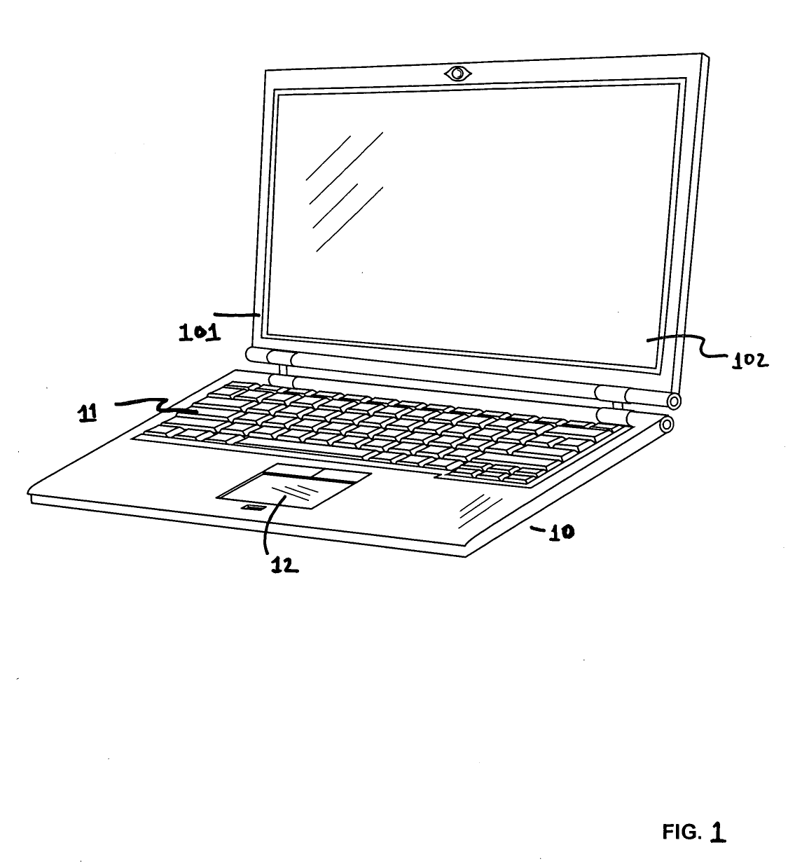

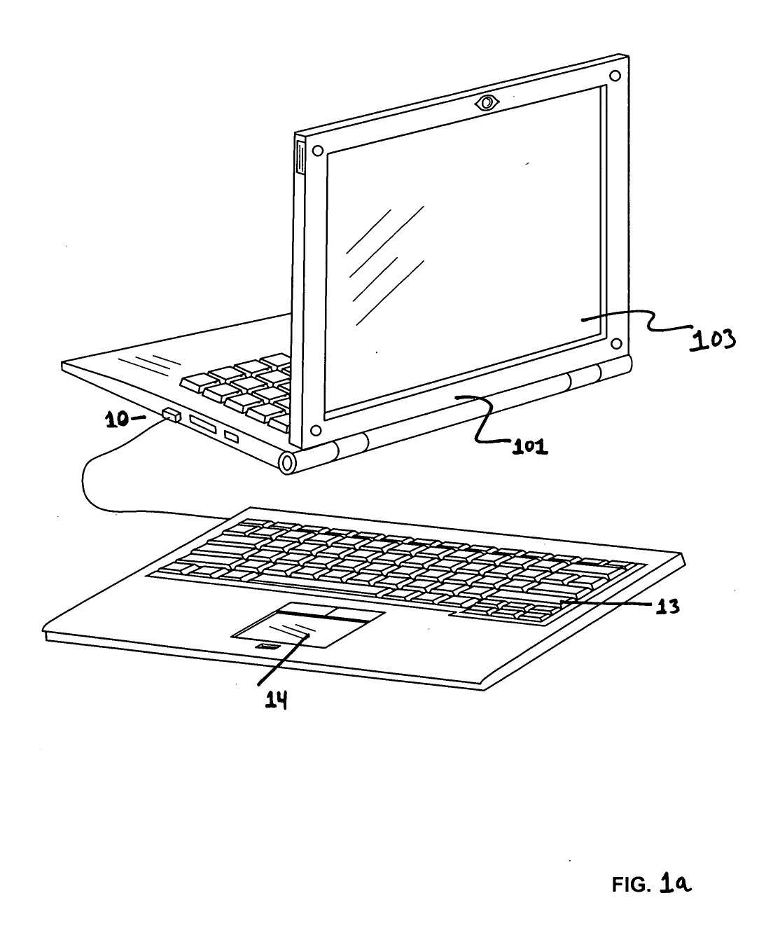

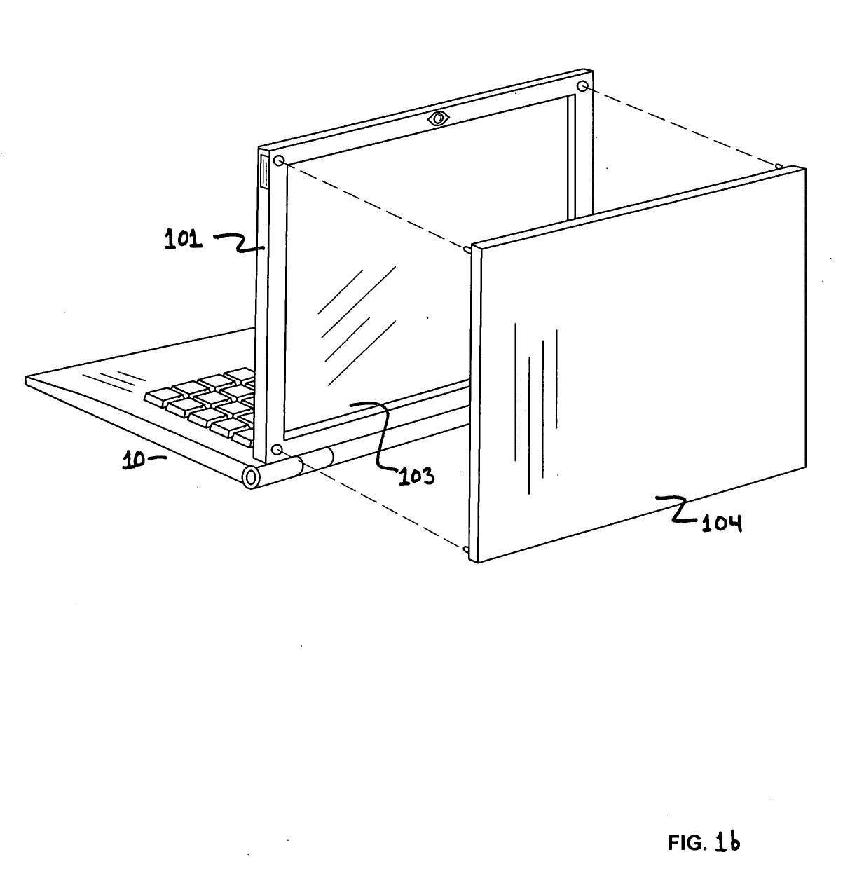

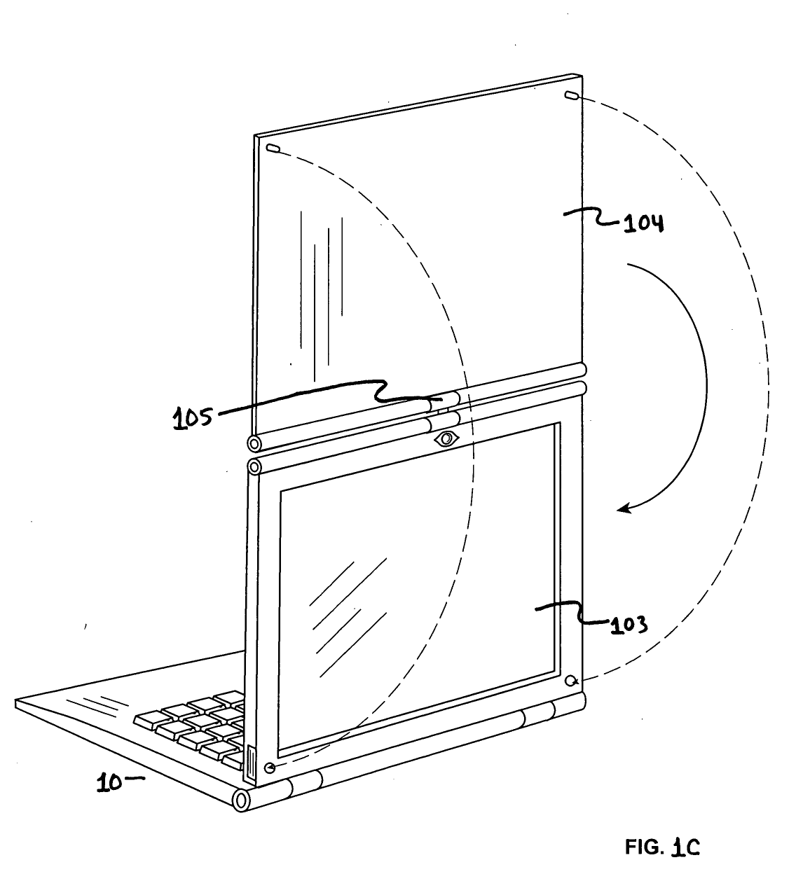

Accordingly, FIG. 1 is an isometric view of a dual display monitor apparatus 10 having a dual display screen monitor frame 101, within which are disposed dual display monitors, the primary display monitor 102 is oriented in a traditional fashion for use by the primary user by means of control apparatus 11 and 12 generally configured as a keyboard 11 and tracking mouse 12. The monitor frame 101 being disposed with an integrated web camera 105. FIG. 1a is an isometric view of the dual display monitor apparatus 10, incorporating a second opposedly situated secondary display screen monitor 103 having a web camera 106. The web camera's can be used conventionally or as a means for multiple users to conference with other computer systems. The second monitor is used in conjunction with the first display monitor so that a single user can display onto the second monitor what is shown on the first monitor. Alternatively, the second monitor can function independently of the first monitor by means of a remote keyboard 13 and tracking mouse 14 which can be attached to the processor of the apparatus by means of, and not limited by, conventional USB ports or other well known communicative means so that multiple users can operate through one device. The remote control devices are shown only in FIG. 1a but can be incorporated in all the embodiments described below.

In FIG. 1b, it may readily be perceived that the second opposedly situated secondary display screen monitor 103, when the apparatus 10 is not in use, or otherwise needs to be closed for storage or transport, may require additional protection. Therefore, in FIG. 1b a protective cover 104 is provided so as to protect the secondary display screen monitor 103, the protective cover 104 being entirely removable, by means of pegs and rubber grommet lined holes in the frame 101 (not labeled) so as to fixedly secure the cover when the device is not in use. In FIG. 1c, the protective cover 104 is shown affixed by a double pivot hinge 105 to the display screen monitor frame 101, such that the protective cover 104 may be rotated to permit the use of the secondary display screen monitor 103.

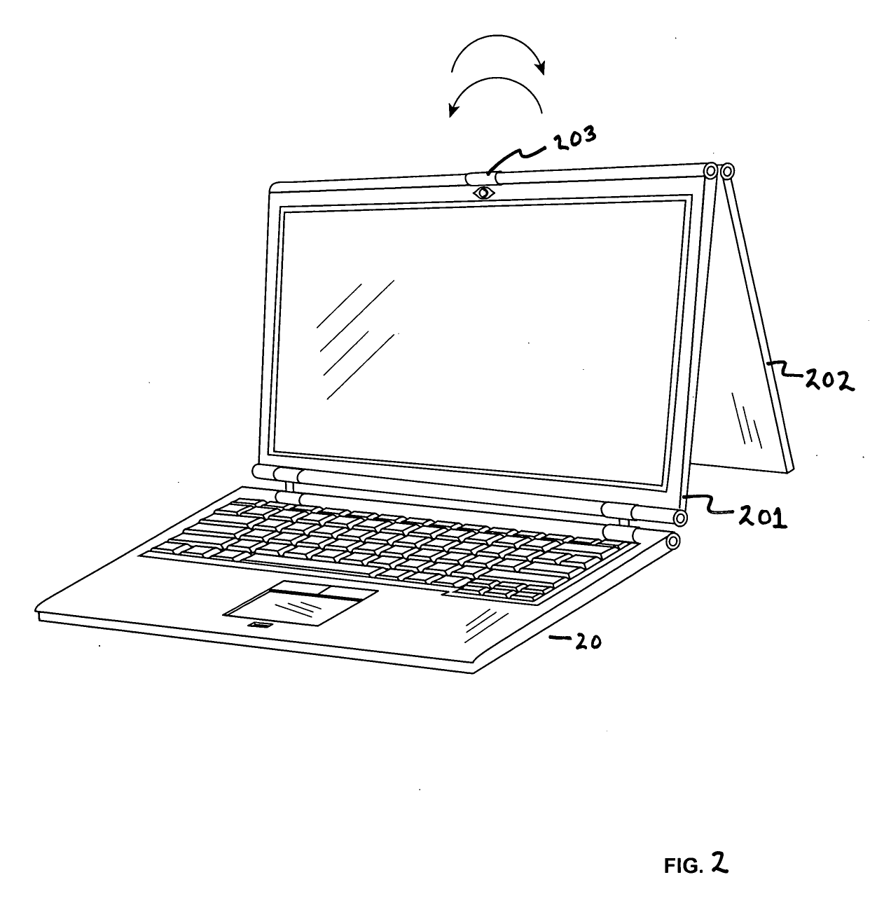

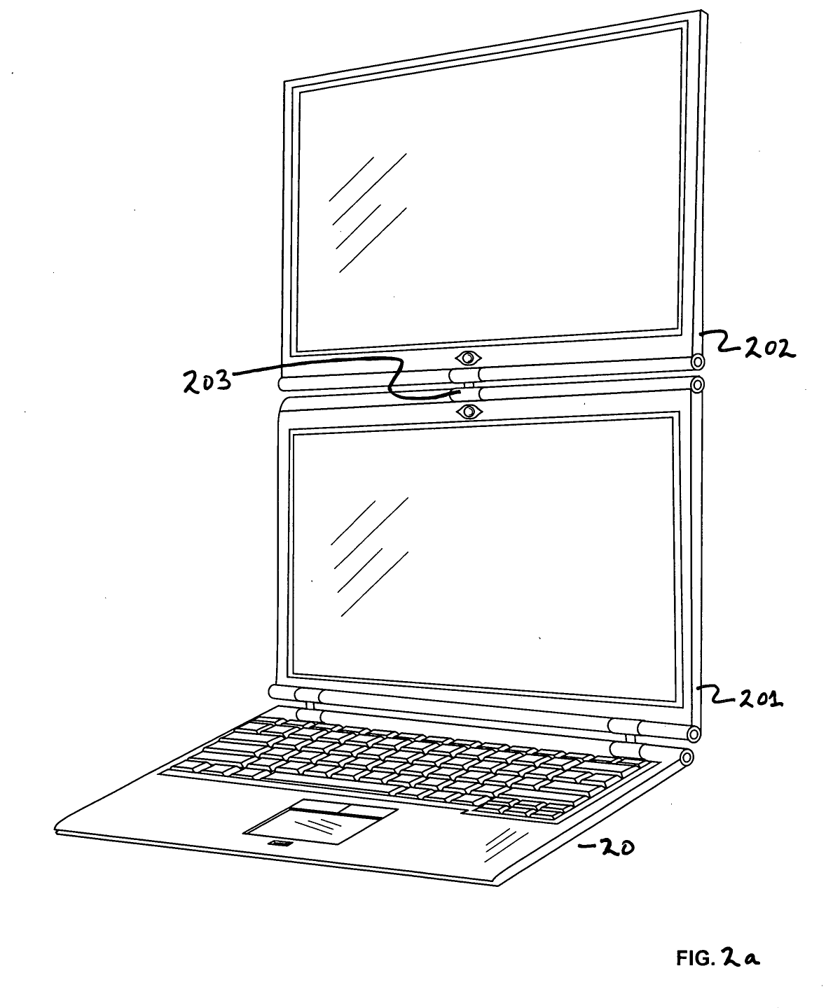

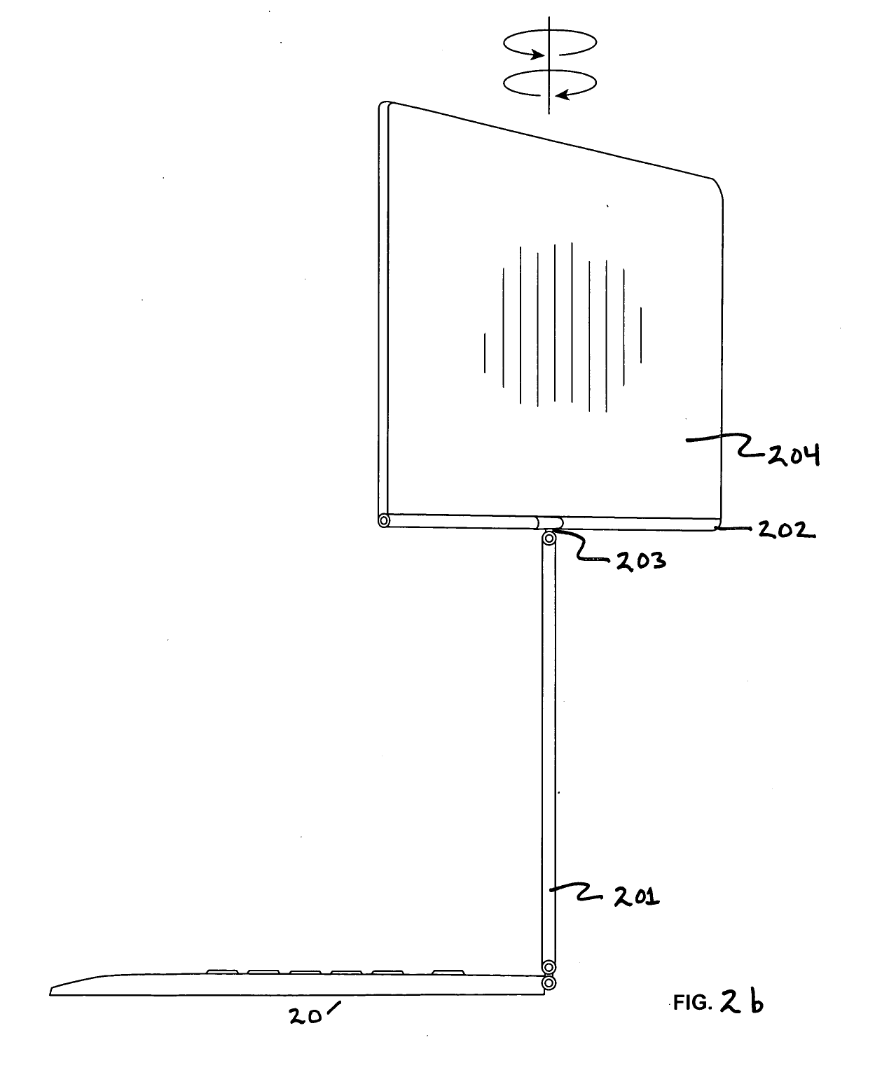

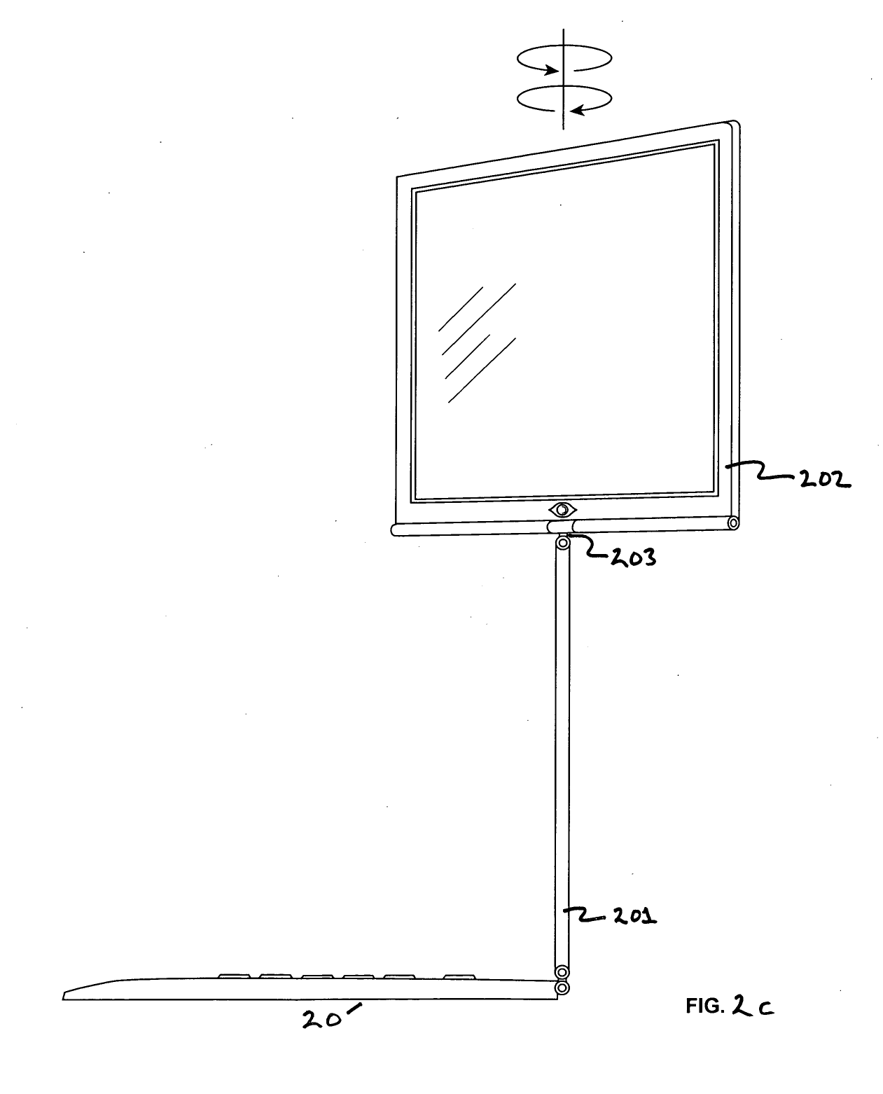

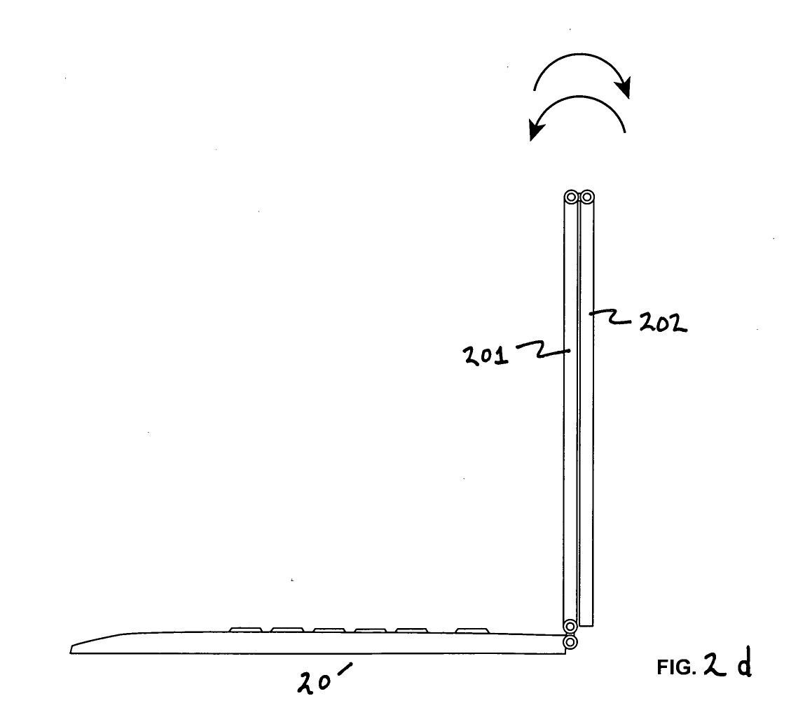

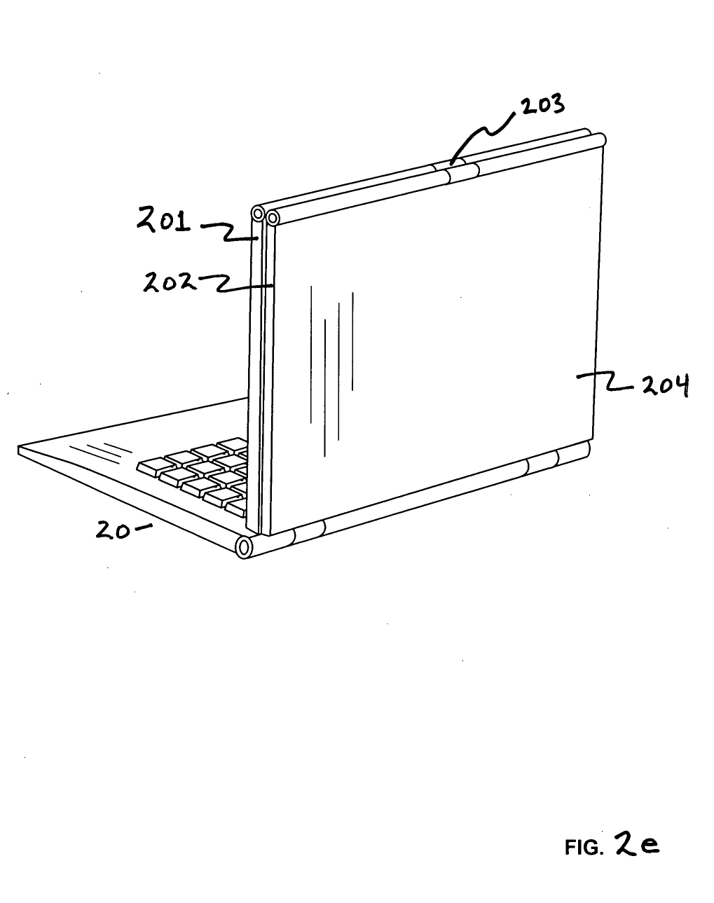

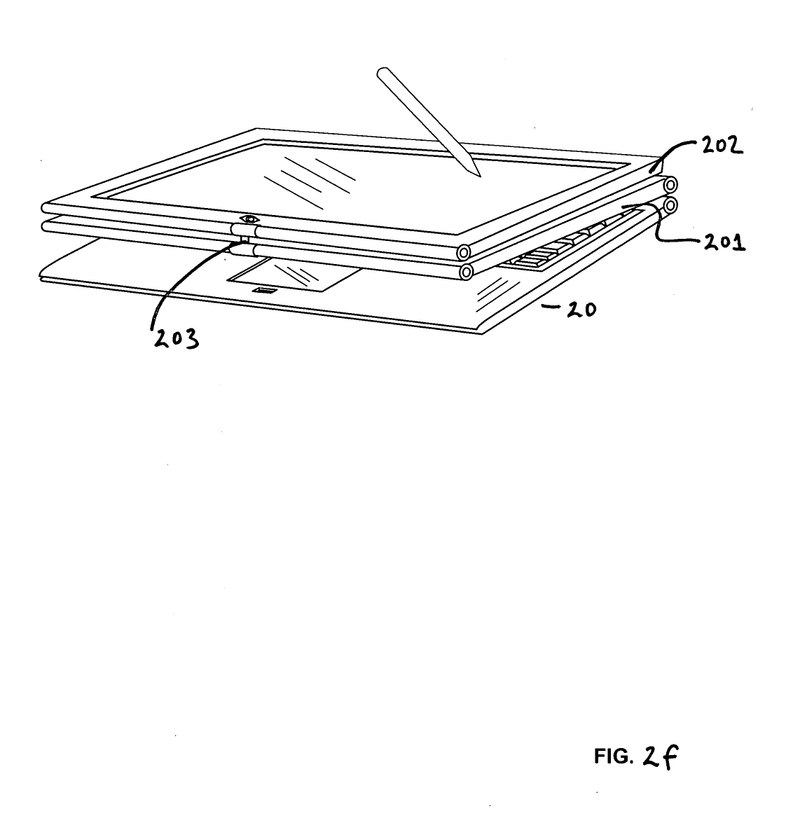

FIG. 2 is an isometric view of the second preferred embodiment of the present invention where the dual display monitor apparatus 20, is comprised of a primary display 201 and a secondary display monitor 202, wherein the display monitors are attached by a dual pivot hinge 203 or other similar movable fixation device which can accommodate the closure of the monitors in a stacked relationship. Web cameras 205 and 206 are disposed respectively on frames (not labeled) used to house the monitors.

FIG. 2a is an isometric view of the second preferred embodiment of a dual display monitor apparatus 20 showing both the primary display monitor 201 and the secondary display monitor 202 in a full upright position, both monitors being oriented for use by the primary user of the apparatus 20.

FIG. 2b is a side elevation view of the second preferred embodiment of a dual display monitor apparatus 20 showing the primary display monitor 201 in an upright position and the secondary monitor display 202 disposed in an upright, turned position on the rotatable dual pivot hinge 203, the secondary display monitor 202 having a protective cover side 204 for use when the dual display monitor display monitor apparatus 20 is in a fully closed orientation.

FIG. 2c is an side elevation view of the second preferred embodiment of a dual display monitor apparatus 20 showing the primary display monitor 201 in an upright position and the secondary monitor display 202 disposed in an upright, turned position on the rotatable dual pivot hinge 203, the secondary display monitor 202 being rotatable on the rotatable double pivot hinge 203 at least 180 degrees such that the secondary display monitor 202 is viewable by either the primary user or the secondary user opposite the primary user.

FIG. 2d is a side elevation view of the second preferred embodiment of a dual display monitor apparatus 20 showing the primary display monitor 201 in an open position and the secondary display monitor 202 folded against the primary display monitor 201 such that the secondary display monitor may be viewed by a second view or user of the dual display monitor apparatus 20.

FIG. 2e is a side elevation view of the second preferred embodiment of a dual display monitor apparatus 20 showing the primary display monitor 201 and the rotatable double pivot hinge 203 in a closed position such that the secondary display monitor 202 is folded against the primary display monitor 201 such that the secondary display monitor viewing surface is positioned against the back of the primary display monitor 201 having the protective surface 204 so as to protect the secondary display monitor 202.

FIG. 2f is an isometric view of the second preferred embodiment of a dual display monitor apparatus 20 showing the primary display monitor 201 and the rotatable double pivot hinge 203 in a closed position such that the secondary display monitor 202 is folded against the primary display monitor 201 such that both display monitors 201 and 202 are folded against the dual monitor display apparatus 20, with the secondary display monitor viewing surface facing outward or upward for use as a tablet-type personal computing device with a touch sensitive screen type display surface.

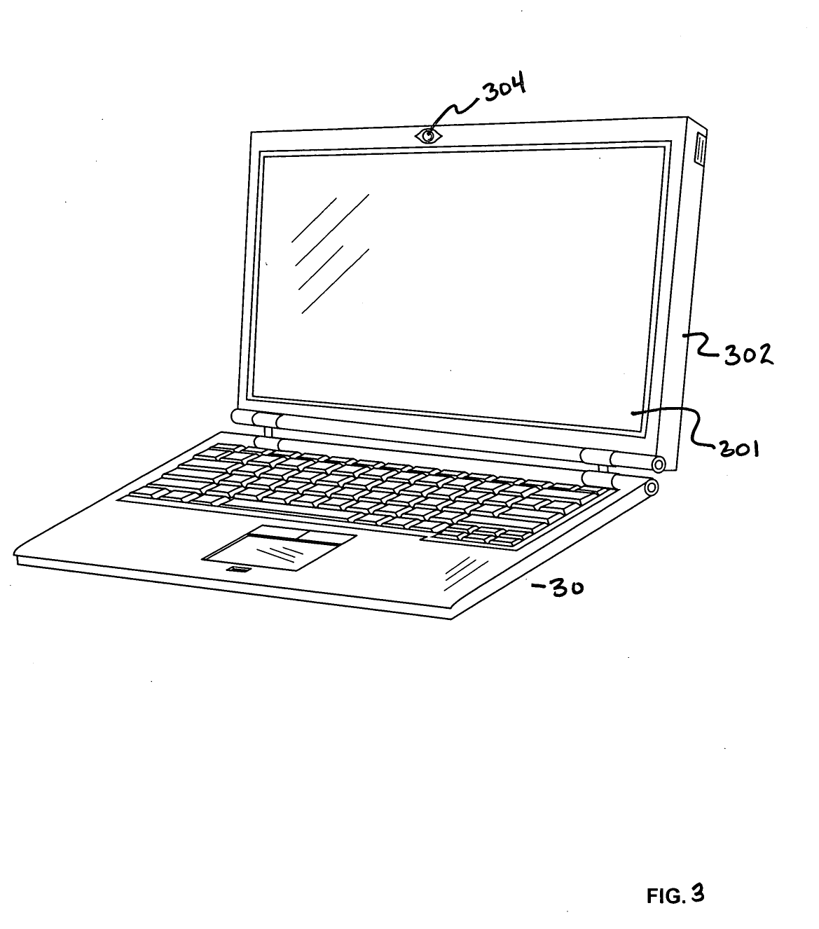

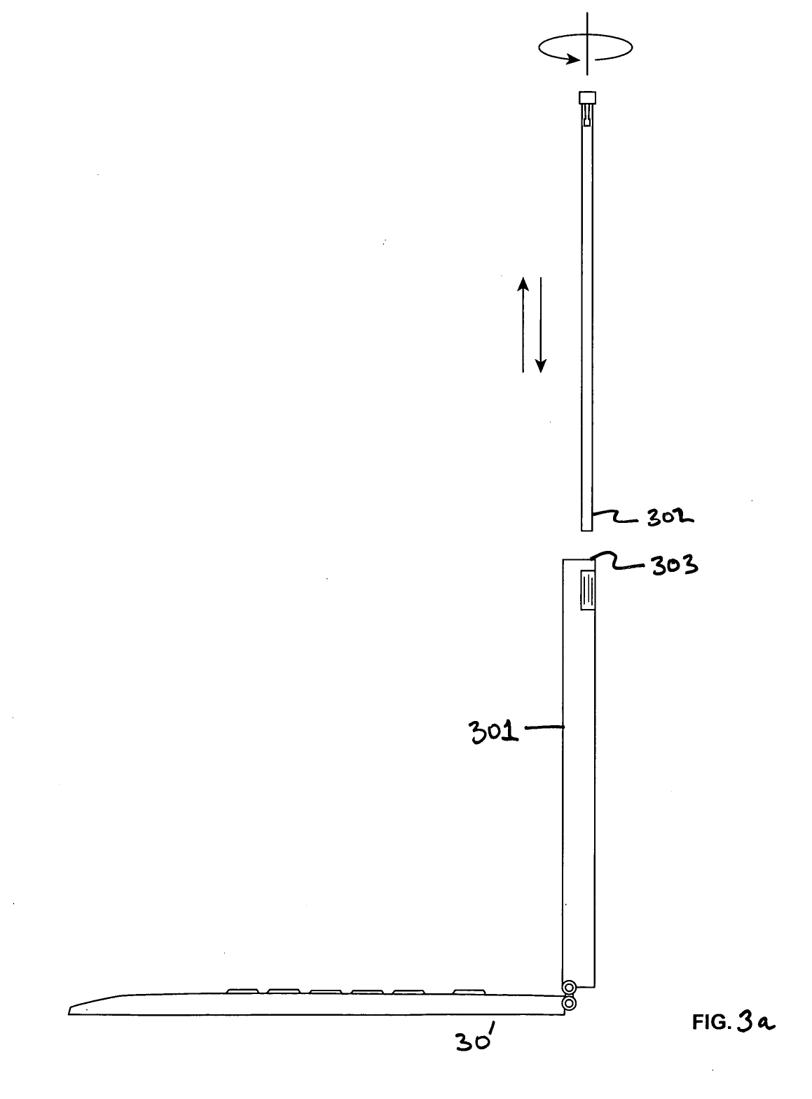

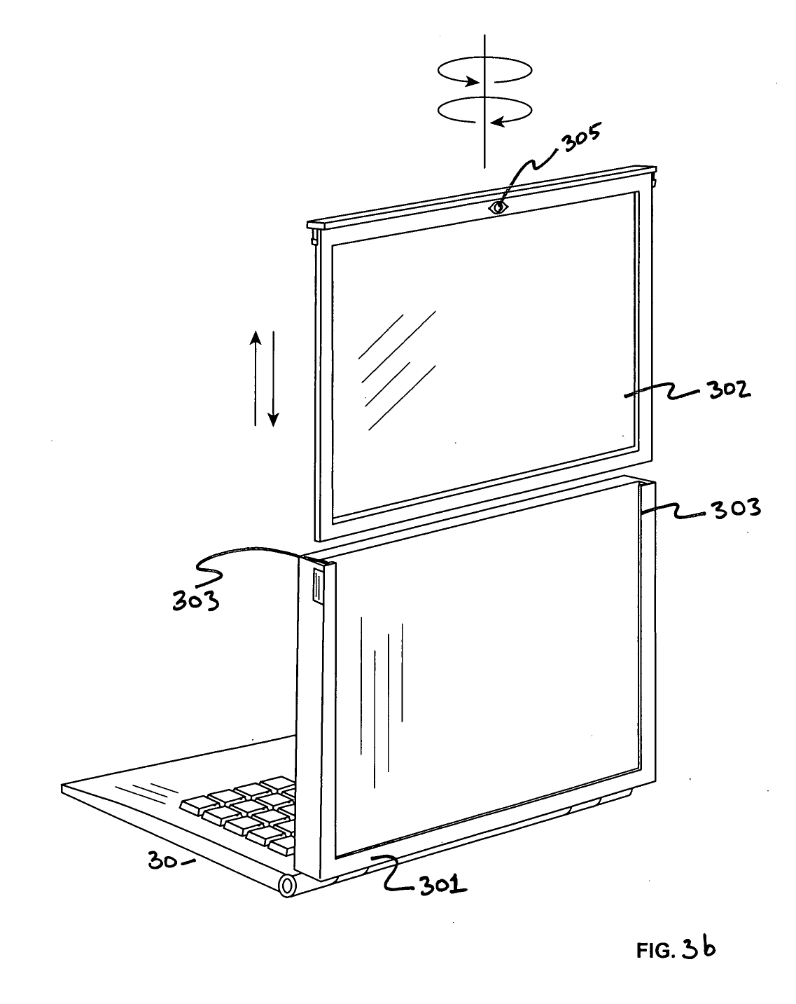

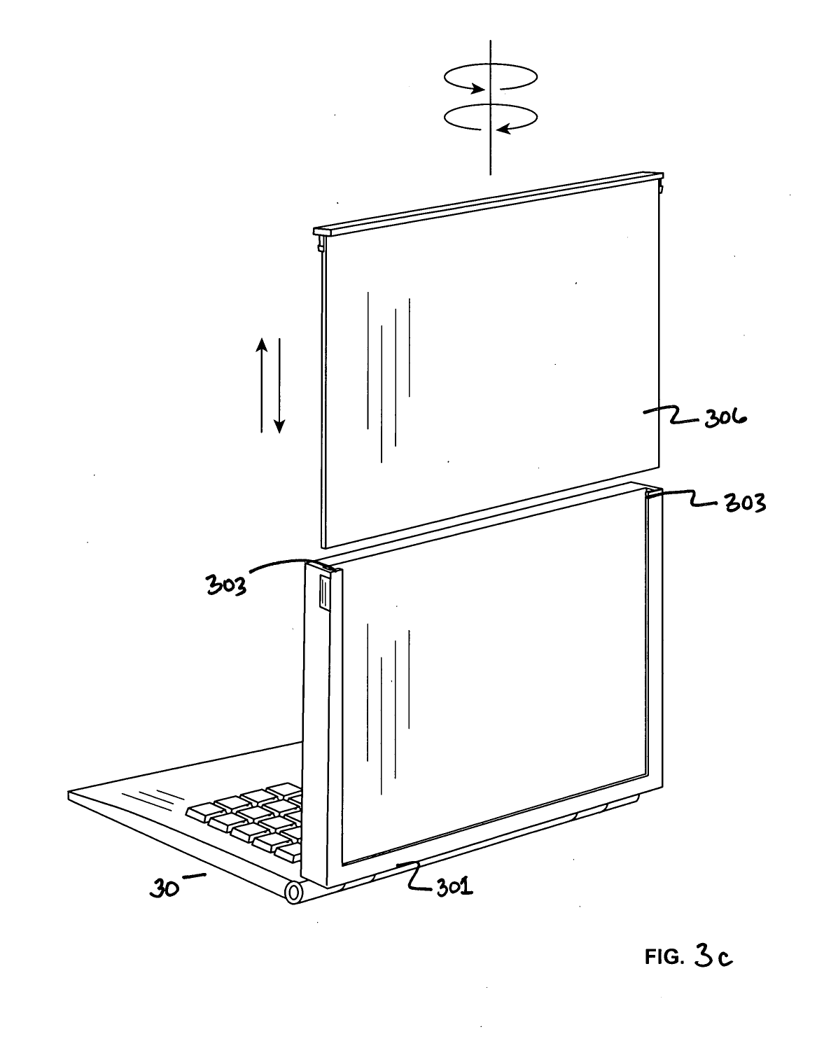

FIG. 3 is an isometric view of a third preferred embodiment of a dual display monitor apparatus 30 showing both the primary display monitor 301 shown in the open position and the secondary display monitor 302 being slidingly disposed within the same frame (not labeled) as the primary display monitor 301. The display monitor having a frame (not labeled) with incorporated web cameras 304 and 305 as shown in FIG. 3a.

FIG. 3a is a side view of the third preferred embodiment of a dual display monitor apparatus 30 showing both the primary display monitor apparatus 301 frame shown in the open position. The secondary display monitor 302 being shown capable of being slid radialy out and radialy in and held by a set of rails, in a vertical manner. The secondary display monitor 302 being capable of being reversed by turning the display monitor apparatus 302 on it's horizontal axis, such that either the display surface or a protective back may be reinserted into the same frame as the primary display monitor 301 resulting in either the secondary monitor or a protective surface being visible to the secondary user.

FIG. 3b is an isometric view of the third preferred embodiment showing the secondary display monitor 302 viewing surface being visible to the secondary user. The secondary display monitor 302 being shown in a vertically withdrawn position above the primary display apparatus and frame 301.

FIG. 3c is an isometric view of the third preferred embodiment showing the secondary display monitor shown rotated on its vertical axis showing a protective cover 306 which is disposed on the back of the removed secondary display monitor. The secondary display monitor 302 being shown in a vertically withdrawn position above the primary display apparatus and frame 301.

As described in detail above, two-sided display monitor apparatus of the present invention may be described as similar to the display monitor on either a conventional lap top type computer or a separate stand-alone type of display monitor but comprised of two display monitors fixedly attached to the enclosure of the lap top type enclosure, enclosed in a stand-alone display monitor or disposed on a stand-alone display monitor. The principal or primary display screen may be used as the primary display monitor for the user and the secondary display screen may be used in conjunction with the primary display monitor or to display specialized information. By reason thereof, the second display monitor may be used simultaneously, concurrently in a concordant manner or for a display having a different purpose or showing different information or graphics from that of the primary display monitor. The apparatus of the present invention can also incorporate built in cameras for use in displaying or capturing images in one or both of the display monitors. The apparatus of the present invention can further incorporate other types of input, such as an additional keyboard or joy stick or other game playing type controller device, television and cable television inputs, CD-ROM, DVD and stereo audio inputs, blue tooth, personal digital assistant input, infra red input, Wi-Fi, Internet telephony input and dual stereo audio outputs to enhance the use dual display monitor apparatus. The terms “dual screen display monitor apparatus”, and “dual screen apparatus” are used interchangeable to refer to the present invention. The instant invention is limited by the claims below.

1. A display monitor apparatus comprising at least one of a central processor, and at least one control apparatus in a housing having a monitor frame, the frame having a first display monitor, and a second display monitor, at least one of which is visible to the user; and at least one input means for each of the separate display monitors, to facilitate the connection of each of the separate display monitors.

2. The display monitor apparatus of claim 1, wherein the second display monitor is situated opposite the first display monitor in the monitor frame.

3. The display monitor apparatus of claim 2, wherein the input means is comprised of a keyboard and tracking mouse so as to input into the second display monitor independently of the first display monitor.

4. The display monitor apparatus of claim 3, wherein the first and second display monitors include a web camera.

5. The display monitor apparatus of claim 4, wherein the second display monitor is provided with a removable cover affixed to the monitor frame.

6. The display monitor apparatus of claim 4, wherein the monitor frame is hingedly connected to a protective cover so as to cover the second display monitor.

7. The display monitor apparatus of claim 1, wherein the monitor frame is comprised of two sections, each section supporting a display monitor, the sections being hingedly and rotationally attached whereby the second display monitor can be positioned opposite the first display monitor.

8. The display monitor apparatus of claim 7, wherein the second display monitor is provided with a protective cover on the opposite side of the display monitor.

9. The display monitor apparatus of claim 8, wherein said display monitors being attached by at least one of a double pivot-type hinge, said hinge being capable of rotation along at least one of an axis of at least 180 degrees.

10. The display monitor apparatus of claim 9, wherein each monitor frame includes a web camera.

11. The display monitor apparatus of claim 7, wherein the input means is comprised of a keyboard and tracking mouse so as to input into the second display monitor independently of the first display monitor.

12. The display monitor apparatus of claim 7, wherein the at least one central processor enables the use of the second display monitor as a tablet type of personal computer.

13. The display monitor apparatus of claim 12, comprising at least one of a display monitor having a touch sensitive type of display surface.

14. The display monitor apparatus of claim 1, wherein the monitor frame is comprised of two rail sections, wherein the second display monitor is supported by the rail sections and slidingly disposed within the frame opposite the first display monitor.

15. The display monitor apparatus of claim 14, comprising at least one of a protective surface on the slidingly removable display monitor, whereby the second display monitor can be rotated to position the protective surface opposite the first display monitor.

16. The display monitor apparatus of claim 14, wherein each display monitor includes a web camera.

17. The display monitor apparatus of claim 14, wherein the input means is comprised of a keyboard and tracking mouse so as to input into the second display monitor independently of the first display monitor.
